(19) United States
(12) Patent Application Publication
(10) Pub. No.: US 2016/0091448 A1
(43) Pub. Date: Mar. 31, 2016

(54) APPARATUS AND METHOD FOR MEASURING ELECTROMAGNETIC PROPERTIES

(71) Applicant: THE UNIVERSITY OF BATH, Bath Bath and North East Somerset (GB)

(72) Inventor: Manuchehr SOLEIMANI, Bath (GB)

(21) Appl. No.: 14/890,889

(22) PCT Filed: May 13, 2014
(86) PCT No.: PCT/GB2014/051460

§ 371 Date: Nov. 12, 2015

(30) Foreign Application Priority Data
May 13, 2013 (GB) 1308551.9

(51) Int. Cl. G01N 27/22; G01N 27/02

(52) U.S. Cl. CPC G01N 27/22; G01N 27/02

(57) ABSTRACT

At least one of apparatus (100, 400) and a method for determining one or more electromagnetic properties of a region of interest are described. One or more inductive measurements (410) corresponding to the region of interest and one or more capacitive measurements (420) corresponding to the region of interest are received. An estimate of electrical conductivity is obtained (430) based on at least the received one or more inductive measurements (410). This is used to determine a permittivity measurement (440) together with at least the received one or more capacitive measurements (420).

### TECHNICAL FIELD

The present invention relates to at least one or more of an apparatus and method for measuring one or more electromagnetic properties.

### BACKGROUND

In many cases it is useful to determine electromagnetic properties of an object or sample. Over the last two to three decades, experimental electrical tomography techniques have been developed to do this. In medical applications, Electrical Impedance Tomography (EIT) systems have been proposed. In these systems conducting electrodes are attached to a sample, for example a portion of a human body, and measurements are used to develop an image of the conductivity or permittivity of the sample. However, such systems are not yet widely adopted in the medical establishment. A related technique is Electrical Capacitance Tomography (ECT). ECT is a method for determining a permittivity distribution in the interior of an object from external capacitance measurements. Like EIT, ECT systems remain mainly experimental. A small number of electrodes are used to develop one or more low resolution images of approximate slices of an object.

Existing electrical techniques are typically only sensitive to a limited range of variables. For example, ECT can be used on non-conducting systems, whilst EIT is applicable to conducting systems. A drawback of EIT for conductivity mapping is that it is necessary for the electrodes to be in direct contact with the sample. Hence, it is not possible to image an entire range of conductivities. This renders it unsuitable in many applications.

### SUMMARY

According to a first aspect, there is provided apparatus for determining one or more electromagnetic properties of a region of interest comprising at least one measurement interface for receiving one or more inductive measurements corresponding to the region of interest and one or more capacitive measurements corresponding to the region of interest and a signal processor communicatively coupled to the at least one measurement interface and arranged to obtain an estimate of electrical conductivity based on at least the received one or more inductive measurements and to determine a permittivity measurement using at least the estimate of electrical conductivity and the received one or more capacitive measurements.

According to a second aspect, there is provided a method of measuring one or more electromagnetic properties of a region of interest comprising receiving one or more inductive measurements corresponding to the region of interest, determining a distribution for electrical conductivity in the region of interest based on at least the received inductive measurements, receiving one or more capacitive measurements corresponding to the region of interest and using at least the distribution for electrical conductivity and the one or more capacitive measurements to determine a distribution for permittivity in the region of interest.

Further features and advantages will become apparent from the following description of certain examples, which is made with reference to the accompanying drawings.

### BRIEF DESCRIPTION OF THE DRAWINGS

FIG. 1A is a schematic illustration showing an apparatus according to a first example and a region of interest;

FIG. 1B is a schematic illustration showing the apparatus according to the first example and a moveable object present in the region of interest;

FIG. 1C is a schematic illustration showing an apparatus according to a second example and a region of interest;

FIG. 1D is a schematic illustration showing an apparatus according to the second example and an insulating region between the apparatus and the region of interest;

FIG. 2A is a schematic illustration showing a plurality of sensor components according to a first example;

FIG. 2B is a schematic illustration showing a plurality of sensor components according to a second example;

FIG. 2C is a schematic illustration showing a plurality of sensor components according to a third example;

FIG. 2D is a schematic illustration showing a plurality of sensor components according to a fourth example;

FIG. 2E is a schematic illustration showing a plurality of sensor components according to a fifth example;

FIG. 3A is a schematic illustration showing an apparatus according to a fourth example;

FIG. 3B is a schematic illustration showing a side view of the apparatus of FIG. 3A;

FIG. 3C is a perspective drawing of a portion of the apparatus of FIGS. 3A and 3B;

FIG. 4A is a schematic illustration showing a signal processor according to an example;

FIG. 4B is a schematic illustration showing the signal processor of FIG. 4A communicatively coupled to a plurality of sensor components;

FIG. 4C is a schematic illustration showing use of a signal controller with the signal processor of FIG. 4B;

FIG. 4D is a schematic illustration showing a first portion of a measurement phase according to an example;

FIG. 4E is a schematic illustration showing a second portion of a measurement phase according to an example;

FIG. 4F is a schematic illustration showing a measurement phase according to another example;

FIG. 5 is a schematic illustration showing an implementation of a signal processor according to an example;

FIG. 6 is a schematic illustration showing use of a tomography processor according to an example;

FIG. 7A shows a photo of a first example region of interest and a corresponding first example output from a tomography processor;

FIG. 7B shows a photo of a second example region of interest and a corresponding second example output from a tomography processor;

FIG. 8 is a flow chart showing a method of measuring one or more electromagnetic properties of a region of interest according to an example;

FIG. 9 is flow chart showing a method of driving one or more sensor component according to an example;

FIG. 10 is a flow chart showing a method of measuring one or more electromagnetic properties of a region of interest according to an example;

FIG. 11A is a schematic illustration of a front view of one example application of an apparatus;

FIG. 11B is a schematic illustration of a side view of one example application of an apparatus;

FIG. 12A shows a photo of an example region of interest in a test case;

FIG. 12B shows an example output for the test case from a comparative Electrical Capacitance Tomography (ECT) processor; and

FIG. 12C shows an example output for the test case from an example tomography processor as described herein.

### DETAILED DESCRIPTION

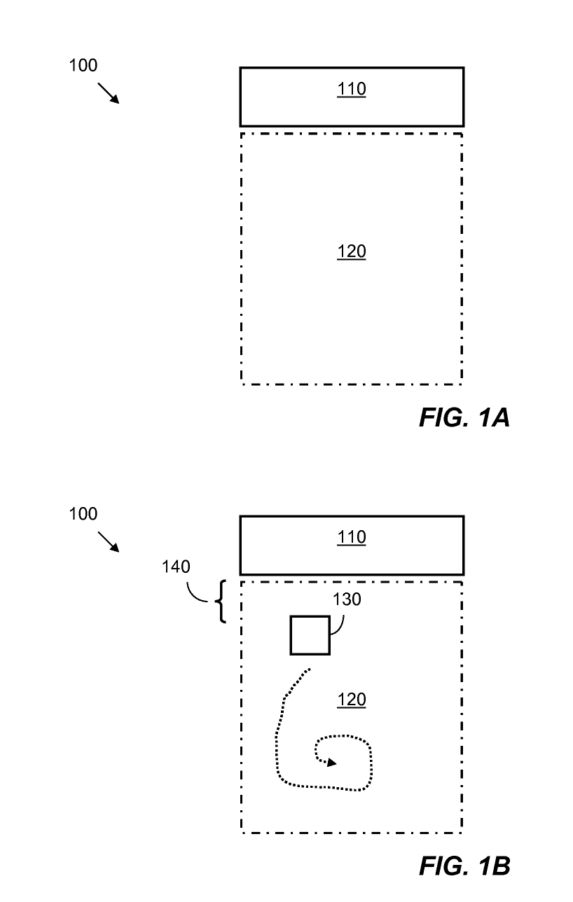

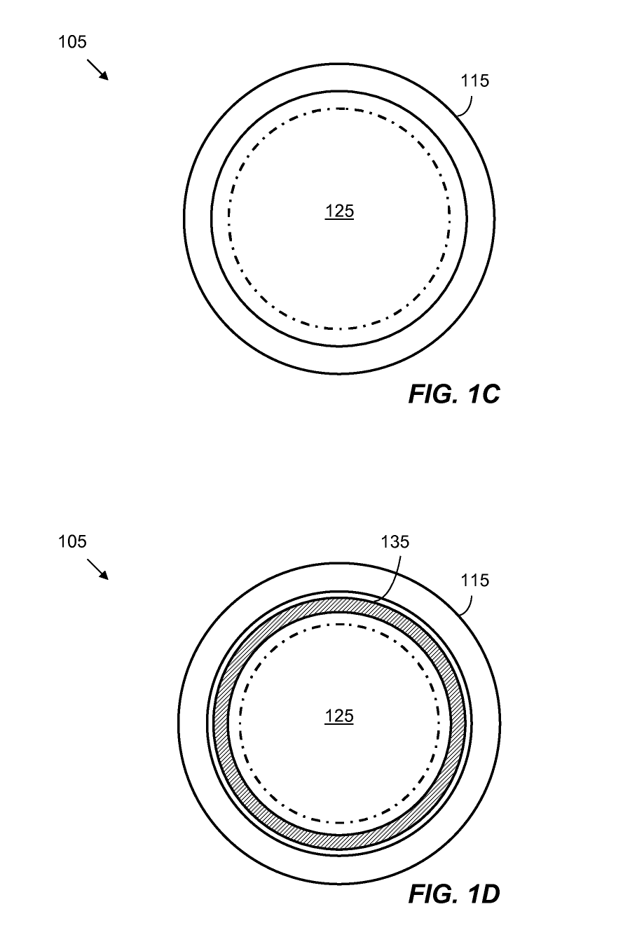

FIG. 1A shows an apparatus 110 according to an example 100. The apparatus 110 is used to measure one or more electromagnetic properties in a region of interest 120. The region of interest 120 may be a space proximate to the apparatus 110, such as a linear region, a two-dimensional area or a three-dimensional volume. The region of interest 120 represents the measurement range for the apparatus 110 and may vary according to implementations.

In certain cases, one or more objects may be present in the region of interest 120. An example of this is shown in FIG. 1B. Any objects may be static or moveable, for example as shown by the dotted arrow in FIG. 1B. An object may be held in a fluid, such as air or a liquid mixture. The fluid may be an insulator such that any object 130 in the region of interest is separated from the apparatus 110 by an insulating region 140. In other words, apparatus 110 may comprise a contactless device, such that measurement of the region of interest 120 and any object 130 within said region may occur without direct electrical contact between the apparatus 110 and either one of at least a portion of the region of interest 120 and any object 130 said region. Alternatively, a fluid or fluid mixture, whether or not they contain any objects, may represent a set of materials to be measured.

FIG. 1C shows another apparatus 115 according to a second example 105. The apparatus 115 is also used to measure one or more electromagnetic properties in a region of interest 125. In this case the region of interest 125 is an enclosed area or volume within a boundary formed by component parts of the apparatus 115. For example, in this case, the region of interest 125 may be the interior of a scanning device or the interior of a pipe carrying one or more fluids. FIG. 1D shows another implementation of the second example wherein the apparatus 115 is separated from the region of interest by one or more intermediate regions 135. At least one of these intermediate regions 135 may comprise an insulating material, for example such that apparatus 115 is separated from the region of interest 125 by an insulator. In this case, apparatus 115 operates in a contactless mode, e.g. there is no direct conductive path between the apparatus 115 and the region of interest 125. For example, apparatus 115 may be arranged external to a pipeline arrangement comprising an inner metal pipe with an outer polymer casing. As is demonstrated by the examples of FIGS. 1A to 1D, the apparatus 110, 115 may be non-invasive, e.g. may be located beside, and need not extend into, the region of interest.

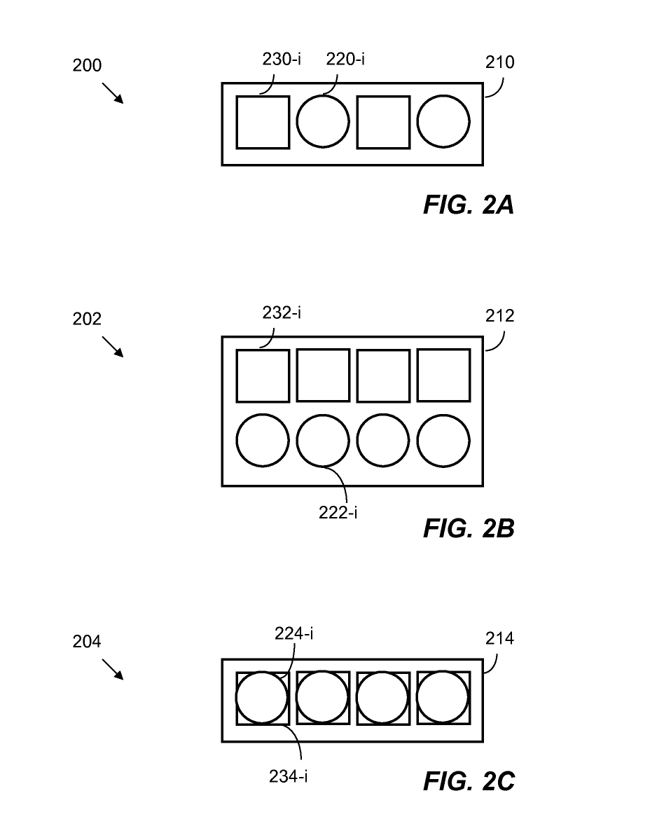

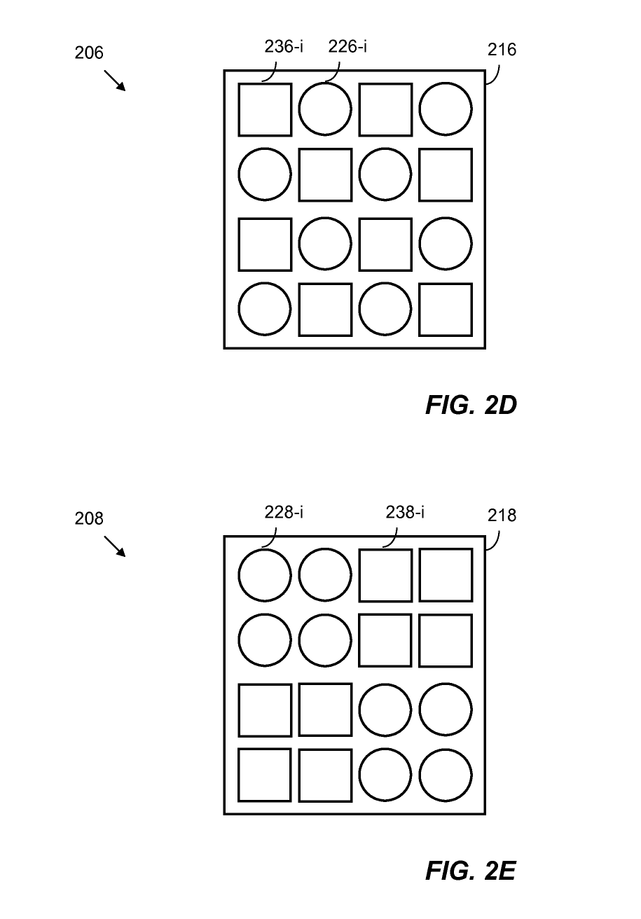

FIGS. 2A to 2E show a number of sensor component arrangements according to a series of examples. These arrangements are shown schematically and as examples to help explain the operation of particular apparatus and methods described herein; other arrangements that are not shown may also be implemented.

FIG. 2A shows a first arrangement 200 of sensor components according to an example. The first arrangement 200 comprises a one-dimensional array 210 of two types of sensor components. A plurality of first sensor components 220 are arranged to provide an inductive measurement corresponding to a region of interest proximate to the one-dimensional array 210. A plurality of second sensor components 230 are then arranged to provide a capacitive measurement corresponding to the same region of interest proximate to the one-dimensional array 210. For example, the plurality of first and second sensor components may be aligned to face onto a region of interest, for example such that the top of one-dimensional array 210 is aligned with the apparatus 110 in FIGS. 1A and 1B or the apparatus 115 in FIGS. 1C and 1D. In the latter case there may be n first sensor components 220 and m second sensor components 230, n and m being such that sensor components are arranged around at least a portion of the perimeter of the region of interest 125. Likewise, although four sensor components are shown in FIG. 2A, n first sensor components 220 and m second sensor components 230 may be employed in an implementation, where n and m are greater than one. In one implementation, the sensor components are not in direct electrical contact with objects and/or the region of interest. In FIG. 2A the sensor components are interleaved in one dimension.

The first arrangement 200 enables a measurement of one or more electromagnetic properties of the region of interest. For example, the first arrangement 200 may output an array of signals: signals from the set of first sensor components may be used to generate a set of conductivity and/or permeability measurements and signals from the set of second sensor components may be used to generate a set of permittivity measurements. These measurements may be in the form of one or more linear arrays, e.g. of lengths n and m or an array of tuples. Capacitive measurements from the second sensor components may represent the relative proportions or characterisation and location of one or more dialectic materials located in the region of interest.

In this case permittivity measurements may represent how an electric field affects, and is affected by, an object or material, such as a dielectric material, located in the region of interest. It may be seen as a measure of resistance to forming an electric field in an object or material in the region of interest. It may be measured in farads per metre (Fm⁻¹). Permeability as referenced herein may represent the ability of an object or material to support the formation of a magnetic field, e.g. a degree of magnetisation obtained by an object or material in response to an applied magnetic field. It may be measured in permeability is measured in Henries per meter (Hm⁻¹), or Newtons per ampere squared (NA⁻²).

In one example, a first sensor component may comprise a coil arrangement, for example of a circular geometry. A second sensor component may comprise a planar square or rectangular plate electrode. There may comprise one or more sets of sensor arrangement sizes, e.g. all second sensor components may be of a common size or there may be a set of second sensor components of a given size and at least another set of second sensor components of a different size. The geometries of the sensor components may depend on the implementation environment. As an example, in one implementation, the first sensor components are around 4 cm in diameter, with 100 turns of copper wire of around 3.5 cm in height and a self inductance of 380 μH; the second sensor components are then copper plates of around 6 cm by 7 cm.

FIG. 2B shows a second arrangement of sensor components 202 according to an example. The second arrangement 202 comprises a first one-dimensional array of first sensor components 222 and second one-dimensional array of first sensor components 222, wherein both arrays are mounted to a common sensor mounting 212. As in FIG. 2A, a first plurality of first sensor components are arranged to provide inductive measurements and a plurality of second sensor components are arranged to provide capacitive measurements. In the case of FIG. 2B four measurements may be recorded from each one-dimensional array of sensor components.

FIG. 2C shows a third arrangement of sensor components 204 according to an example. In this case, a first sensor component 224 and a second sensor component 234 are combined and coupled to sensor mounting 214. For example, they may be combined in a common electrode arrangement. This may comprise, amongst others, a coil mounted upon a plate electrode or a helical or conical coil arranged to measure capacitance as well as inductance. The same shielding may be used for both capacitive and inductive measurements. Alternatively the two sets of sensor components may be mounted in separate planes that are aligned along common sensor component axes. The third arrangement 204 has an advantage of increased sensor density and measurement correspondence.

FIGS. 2D and 2E show two arrangements that may be used to provide a two dimensional array of inductance and capacitance measurements according to examples. FIG. 2D shows a plurality of first sensor components 226 and a plurality of second sensor components 236 that are interleaved in two dimensions. The sensor components in this example may be arranged in a common plane or sensor mounting 216. Alternatively, the example of FIG. 2E shows a planar array with grouped sets of sensor components of each type, e.g. two sets of first sensor components 228 and two sets of second sensor components 238 arranged in a common plane or sensor mounting 218.

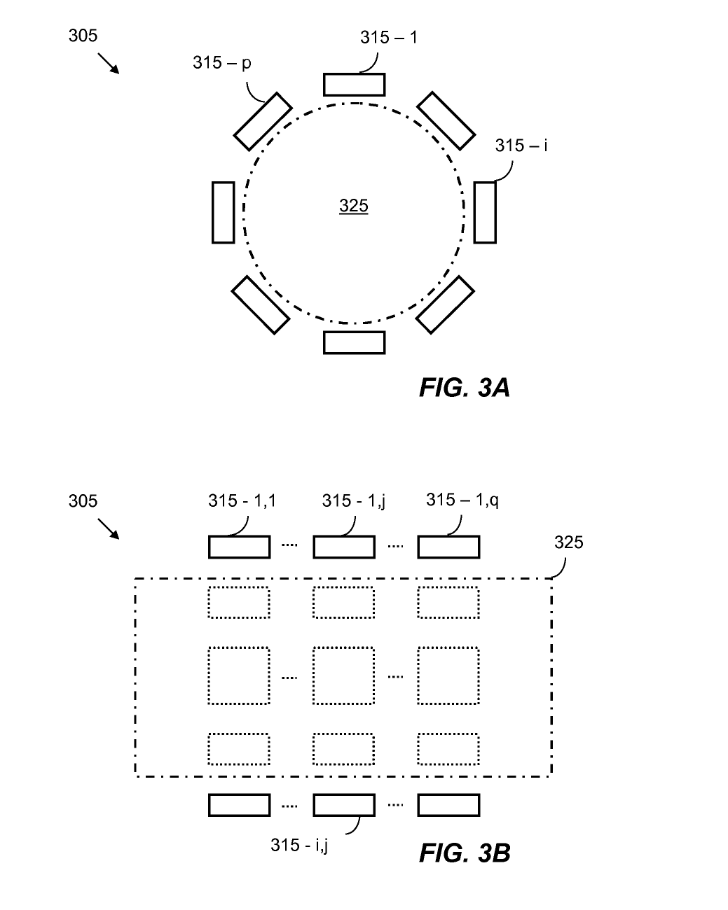

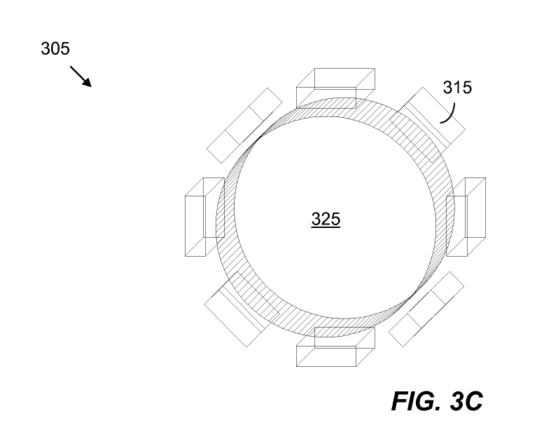

Although the arrangements shown in FIGS. 2A to 2C are shown as being one-dimensional planar arrangements, they may be scanned or swept in one, two or three dimensions to provide measurements for a region of interest having a given area or volume. One arrangement for providing measurements in three dimensions is described below with reference to FIGS. 3A to 3C.

FIG. 3A shows a cross section of a sensor arrangement 305 for measuring one or more electromagnetic properties of a region of interest 325. In this example the region of interest 325 may comprise, amongst others, the interior of a device, wherein objects of interest are played in said region, or a pipe or conduit carrying one or more fluids. In FIG. 3A a series of p sensor mountings 315 are arranged around the periphery of the region of interest 325. In one implementation they may be coupled to a superstructure encompassing the region of interest 325. In another implementation they may be individually coupled to a structure comprising the region of interest, such as a pipe or conduit. Each sensor mounting 315 comprises one or more first sensor components and/or one or more second sensor components. For example, each sensor mounting may comprise at least a portion of the sensor components shown in sensor mountings 210 to 218 shown in FIGS. 2A to 2E.

FIG. 3B shows a side view of the same sensor arrangement 305. In this example there are q rings of sensor mountings 315. The sizes and/or configurations of sensor components may vary between one or more rings. FIG. 3C shows one ring of sensor mountings in a perspective view. The sensor mountings 315 of each ring may be coupled to each other and/or a superstructure, or they may be mounted to a structure comprising the region of interest. The set of p by q sensor mountings 315 encompass a volume. Measurements may then be obtained for objects and/or fluids within the volume. In certain cases any of the arrangements used in FIGS. 2A to 2E may be applied along the longitudinal axis shown in FIG. 3B; for example, the distribution along the horizontal axis in FIGS. 2A to 2E may be applied along the horizontal axis in FIG. 3B.

The sensor systems described above may, for example, be applied to non-invasively measure and/or image multiphase flows. In certain examples, sensor components are interleaved to optimise the overall sensitivity distribution of an apparatus. The sensor components may be arranged in a one, two or three-dimensional arrangement. For example, a set of sensor components integrated in a single plane allows two-dimensional imaging with any mixture of non-conducting and conducting media. More detailed characterisation may then be achieved with an integrated three dimensional sensor. For example, the arrangement 305 in FIGS. 3A and 3C may be provided for any shape or three-dimensional volume. A number of geometries that are not shown in the examples are possible.

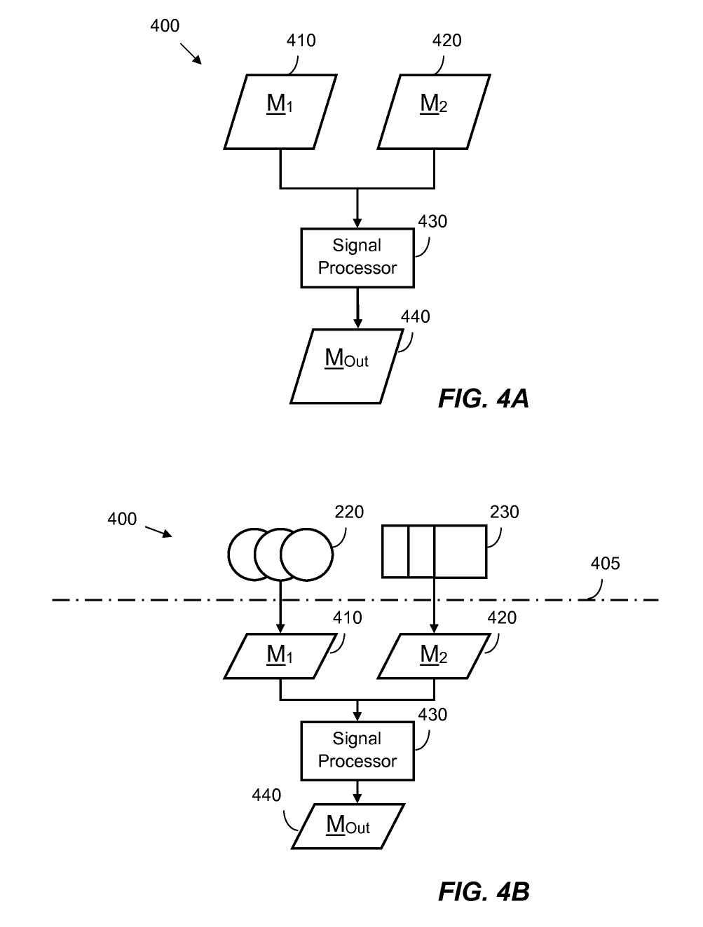

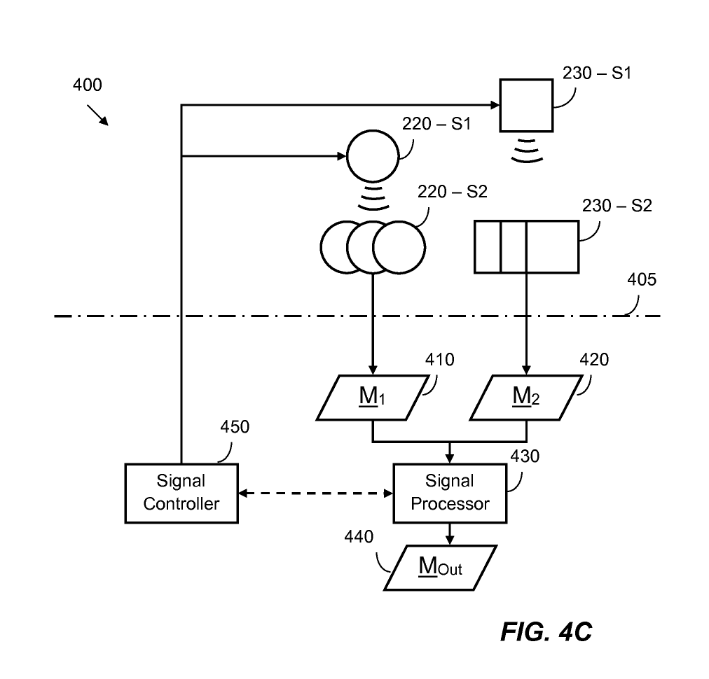

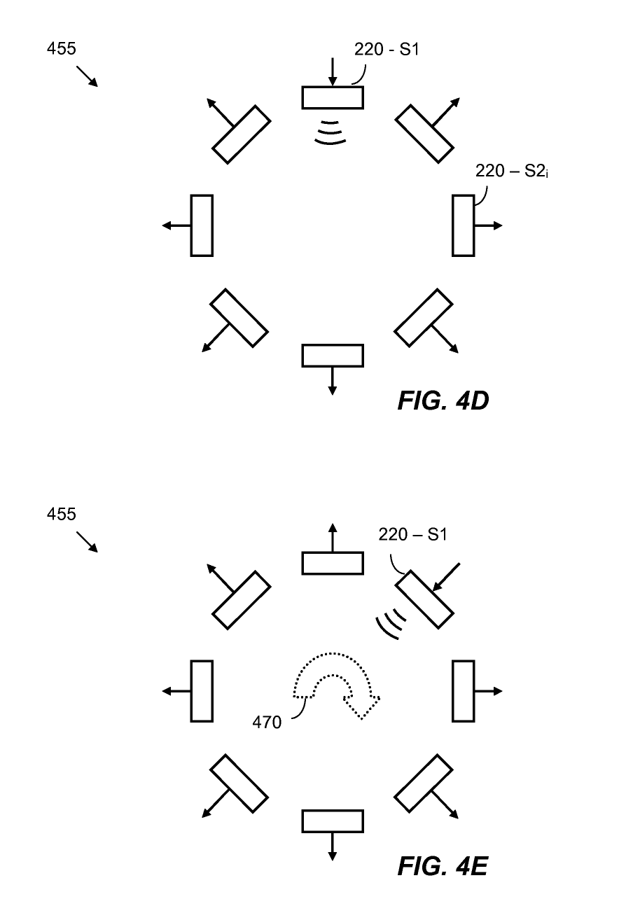

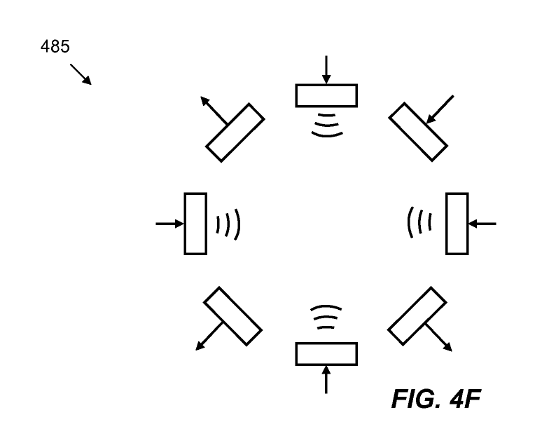

FIGS. 4A to 4C show a signal processor that may be used with the sensor arrangements of any one of FIGS. 2A to 3C. In certain cases the signal processor may be used with sensor arrangements that are not shown. The signal processor may also be referred to as a measurement processor.

FIG. 4A shows two sets of measurement data M₁ 410 and M₂ 420. This may be data that is respectively received from a plurality of first sensor components and a plurality of second sensor components, such as any of components 220 to 228 and 230 to 238 in FIGS. 2A to 2E. In certain examples, the first set of measurement data M₁ 410 may comprise inductive measurements and the second set of measurement data M₂ 420 may comprise capacitive measurements. Although two sets of data are described for ease of explanation, in certain implementations these sets may be combined into a single set of measurements. For example, a combined system may produce complex impedance images that can be represented in variety of ways. In one example, a particular complex impedance image may be a single image representative of complex impedance quantities. In one implementation, measurement data M₁ 410 and/or M₂ 420 may comprise digital voltage values, for example as received from an analog-to-digital convertor electrically coupled to the sensor components. The sets of measurement data M₁ 410 and M₂ 420 are received by a signal processor 430. There may be one or more pre-processing modules between the sensor components and the signal processor 430. For example, measurement data M₁ 410 and M₂ 420 may be pre-processed by, amongst others, one or more of amplifiers, filters (such as low-pass filters), latches, buffers, integrators, transceivers, multiplexers etc. The signal processor 430 is arranged to determine one or more electromagnetic properties based on the measurement data M₁ 410 and M₂ 420. Values for the one or more electromagnetic properties are output as measurement data M_{OUT} 440.

For example, the signal processor 430 may be arranged to determine an electrical conductivity measurement for the region of interest based on the first set of measurement data M₁ 410. One or more values for this electrical conductivity measurement may be output by the signal processor 430 as measurement data M_{OUT} 440. In certain cases that are not shown in FIG. 4A, the signal processor 430 may access an electrical conductivity measurement determined by another component, e.g. access via a shared memory and/or storage device. The signal processor 430 may also be arranged to use the electrical conductivity measurement as input parameters to determine a permittivity measurement based on the measurement data M₂ 420. One or more values for this permittivity measurement may be output by the signal processor 430 as measurement data M_{OUT} 440. In certain examples, the signal processor 430 may determine a complex conductivity measurement for a region of interest based on measurement data M₁ 410 and M₂ 420 and output this as measurement data M_{OUT} 440. The measurement data M_{OUT} 440 may then be used to characterise materials and structures within the region of interest, including complex materials and structures comprising a combination of conducting and dielectric portions.

In certain cases, estimates of permittivity (e.g. magnetic permeability) determined by the signal processor 430 may be fed back into one or more models used by said processor. For example, an estimate of permittivity may be used to correct and/or calibrate subsequent inductive measurements. There are certain materials and/or processes where there is a correlation between conductivity and permittivity. In certain examples this mutuality may be used to further enhance the imaging fusion. This may improve the accuracy of subsequent electrical conductivity and/or permeability measurements. In one case, one or more state models may be used wherein the determined conductivity, permeability and/or permittivity measurements are used to iteratively and/or probabilistically converge on a characterisation of the region of interest. For example, Kalman filters may be applied to the measurements to account for dynamic aspects of the imaging process. In certain examples, the generation of conductivity and/or permeability measurements and permittivity measurements may take place iteratively in separate phases; in other cases an integrated reconstruction process may be used.

FIG. 4B shows the signal processor 430 communicatively coupled to one or more first sensor components 220 and one or more second sensor components 230. The signal processor 405 is communicatively coupled to the sensor components 220, 230 via a measurement interface 405. The measurement interface 405 may comprise one or more electrical and/or integrated circuits to enable signal processor 430 to receive measurement data M₁ 410 and M₂ 420 in a form suitable for processing. In one implementation the measurement interface 405 may comprise one or more of a demultiplexer, an amplifier, a transceiver and a Field Programmable Gate Array (FPGA) analog-to-digital converter.

FIG. 4C shows an example where a signal controller 450 is used to provide one or more signals to the sensor components 220, 230. In FIG. 4C, the signal controller 450 is communicatively coupled to one or more of the first sensor components 220 and one or more of the second sensor components 230. In other examples, a separate signal controller may be provided for each set of sensor components. In FIG. 4C, the signal controller 450 is communicatively coupled to the sensor components 220, 230 via the measurement interface 405. In this case, the measurement interface 405 may comprise one or more pre-processing elements such as one or more an FPGA analog-to-digital convertor, an amplifier, a transceiver and a multiplexer. In one implementation, the signal controller 450 is communicatively coupled to the signal processor 430. In this case, one or more signals generated by the signal processor 430 may be received by the signal processor 430. These signals may be used in the signal processing performed by the signal processor 430. Alternatively, in other examples, if one or more signals are generated according to a predetermined function and/or timebase, the signals may be replicated independently by the signal processor 430. Similarly, in certain examples, the signal controller 450 may receive data from the signal processor 430; for example, timing and/or sensor component selection information.

In FIG. 4C, during at least a portion of a measurement phase, at least one of the first sensor components 220-S1 is selected to receive a first signal. For example, where the first sensor components comprise one or more coils, a particular coil may be selected to receive a first signal in at least a portion of a measurement phase. The first signal may be a direct current and/or an alternating current. If an alternating current is used the first signal may comprise one or more frequency components. In this case, in certain examples, a range of frequencies may be swept in a measurement phase; for example, such that a portion of a measurement phase, Δt, is associated with a particular frequency component. In one example 455 illustrated schematically in FIG. 4D, one of the first sensor components 220-S1 may be selected to be driven in a particular portion of a measurement phase, wherein measurements are obtained using the remaining first sensor components 220-S2. A different first sensor component in the set of first sensor components may be iteratively selected in each portion of the measurement phase, for example as shown in FIG. 4E by arrow 470, such that a plurality of first sensor components (in certain cases the complete set) are each driven by the first signal. The first signal may stay the same or may be varied for each first sensor component, depending on the implementation and measurement requirements. In another example, there may comprise a set of two of more first sensor components that are arranged to be driven by a first signal and a set of two or more first sensor components that are arranged to provide measurements in response to the application of the first signal. This is shown in the example 485 of FIG. 4F. Measurements may be provided as one or more of voltage and current measurements.

Similar configurations may apply for the second sensor components 230. For example, at least one of the second sensor components 230-S1 may be selected to receive a second signal. For example, where the second sensor components comprise one or more electrodes, a particular electrode may be selected to receive a second signal in at least a portion of a measurement phase. The second signal may be a direct current and/or an alternating current. This may result in a fixed or varying voltage applied to an electrode. If an alternating current is used the second signal may also comprise one or more frequency components. This may be the same range of frequencies as the first signal, or alternatively may comprise one or more different ranges of frequencies. In one example, one of the second sensor components 230-S1 may be selected to be driven in a particular portion of a measurement phase, wherein measurements are obtained using the remaining second sensor components 230-S2. A different second sensor component in the set of second sensor components may be iteratively selected in each portion of the measurement phase, such that a plurality of second sensor components (in certain cases the complete set) are each driven by the second signal. The second signal may stay the same or may be varied for each second sensor component, depending on the implementation and measurement requirements. In another example, there may comprise a set of two of more second sensor components that are arranged to be driven by a second signal and a set of two or more second sensor components that are arranged to provide measurements in response to the application of the second signal. Measurements may be provided as one or more of voltage and current measurements. Inductive and capacitive measurements may be performed sequentially. One or more of the first and second signals may be pulse and/or sinusoidal signals. They may both be in phase or have different phases. In certain cases the first and second signals may comprise different components of a single signal, e.g. may represent two modulations of an underlying carrier waveform and/or different DC and AC components of a common signal. This may be the case when inductive and capacitive measurements are performed at the same time.

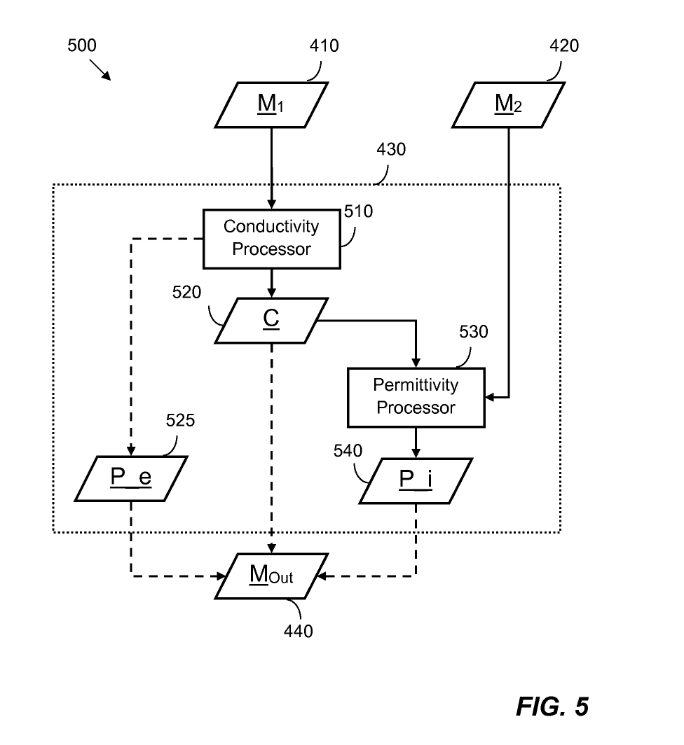

FIG. 5 shows certain sub-modules of a signal processor 430 according to an example 500. The sub-modules shown may not be exhaustive, other sub-modules may be provided and/or sub-modules may be omitted as required. The signal processor 430 of FIG. 5 comprises a conductivity processor 510 and a permittivity processor 530. The conductivity processor 510 is arranged to receive measurement data M₁ 410 and determine an electrical conductivity distribution C 520 in the region of interest. The conductivity processor 510 may also be arranged to determine a permeability distribution P_e 525. The permittivity processor 530 receives at least the electrical conductivity distribution C 520, for example it may be communicatively coupled to the conductivity processor 510. The permittivity processor 530 is arranged to receive measurement data M₂ 420 and determine a permittivity distribution P_i 540 in the region of interest. One or more of the electrical conductivity distribution C 520, the permeability distribution P_e 525, and the permittivity distribution P_i 540 may form the output of the signal processor M_{Out} 440.

In one example, the conductivity processor 510 uses an eddy current model to determine the electrical conductivity distribution C 520 in the region of interest. The eddy current model may be used to define a Jacobian matrix. The Jacobian matrix may be defined using a finite element method applied to the eddy current model. The Jacobian matrix and measurement data M₁ 410 may then be used in a series of linear equations. These linear equations may be solved to determine the electrical conductivity distribution C 520 in the region of interest. This process may also result in the permeability distribution P_e 525 in the region of interest. In other implementations non-linear methods may also be used to solve an inverse problem to determine the electrical conductivity distribution C 520 based on a model of the system.

In one example, the permittivity processor 530 uses a permittivity model to determine a permittivity distribution P_i 540 in the region of interest. This permittivity model may take as a set of parameters an electrical conductivity distribution, such as the distribution C 520 discussed above. A further Jacobian matrix may be defining using a finite element method applied to the permittivity model. The further Jacobian matrix may represent Jacobian matrix will represent how measured capacitances vary with permittivity. The further Jacobian matrix and measurement data M₂ 420 may then be used in a series of linear equations. These linear equations may be solved to determine the permittivity distribution P_i 540 in the region of interest. As previously, in other implementations non-linear methods may also be used to solve an inverse problem to determine the permittivity distribution C 520 based on a model of the system.

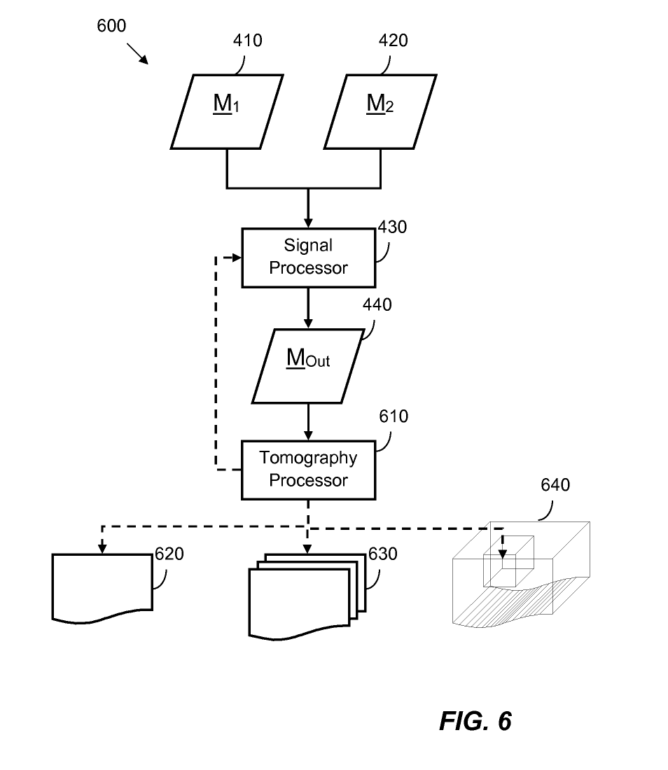

FIG. 6 shows an example 600 that demonstrates how values for one or more electromagnetic properties that are determined by a signal processor may be used by a tomography processor. FIG. 6 shows the arrangement of FIG. 4A communicatively coupled to a tomography processor 610. The tomography processor 610 is arranged to receive measurement data M_{OUT} 440 that is output by the signal processor to generate tomograms, e.g. images, of the region of interest. As shown in FIG. 6 the tomography processor 610 may be arranged to output one or more of single slice images 620 of a region of interest (e.g. representing a planar area of said region), a plurality of slice images 630 of a region of interest (e.g. representing a volume in planar slices) and a three-dimensional representation 640 (e.g. representing a volume of the region of interest). In certain cases the signal processor 430 and/or a signal controller 450 may operate under the control of the tomography processor 610. For example, data generated by the signal processor 430 during a measurement phase may be used by the tomography processor 610 to generate a particular tomogram 620, wherein the tomography processor 610 controls the parameters of the signal processor 430 to begin a subsequent measurement phase and obtain another tomogram representing another slice of the region of interest. In the case of the apparatus 315 of FIGS. 3A to 3C, the tomography processor 610 may control the selection of one or more of the sensor mounting 315-i,j so as to produce different slices of the region of interest 325. In certain cases the tomography processor 610 may control the generation of data to map one or more electromagnetic properties of a volume, for example control the generation of voxels (volumetric pixels) representing values of said properties. These may be calculated directly in a volume space, e.g. without determining separate image slices. In certain cases, the images or volumes may be generated in association with a particular time value, e.g. as a frame of a video. In a three-dimensional case, voxels may comprise doxels (dynamic voxels) that have both a value for three spatial dimensions and time. The tomography processor 610, in addition to signal processor 430 or on its own, may also provide post-processing such as normalisation and/or statistical processing to generate a two or three dimensional image of property values for the region of interest. As shown by the example of the three-dimensional representation 640 in FIG. 6, the output of the tomography processor 610 may enable property values for one or more objects resident in the region of interest to be viewed. This could be used, for example, for measurement and/or object detection.

In one example, the apparatus 600 of FIG. 6 may comprise an integrated magnetic induction and electrical capacitance tomography (IMIECT) device. If operating in three-dimensions, this device is able to characterise materials and structures volumetrically. These multi-dimensional images or recordings may represent a full complex impedance map of a material or an object. In images colour may be used to represent variable values, class of electromagnetic property and/or frequency of operation amongst others. If a single image is used to represent a plurality of electromagnetic properties in one single image, then, for example, image values may represent an amplitude of a complex impedance.

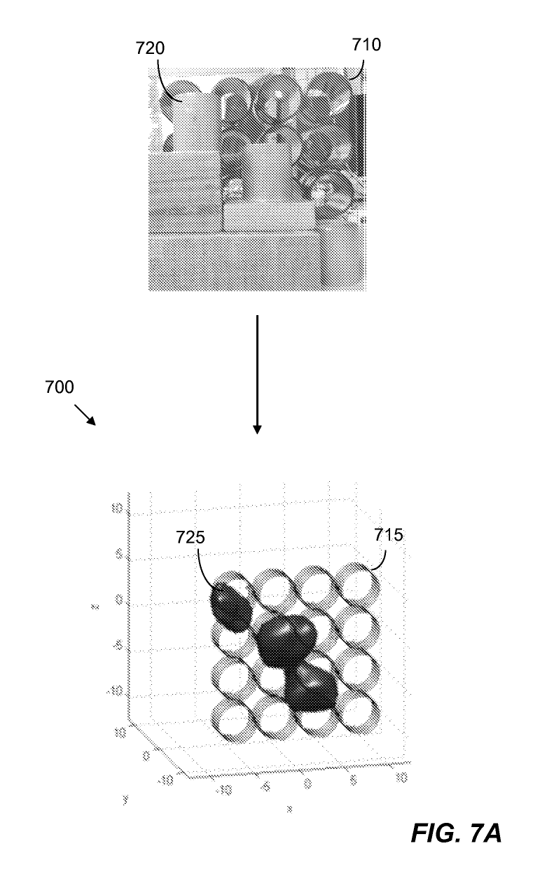

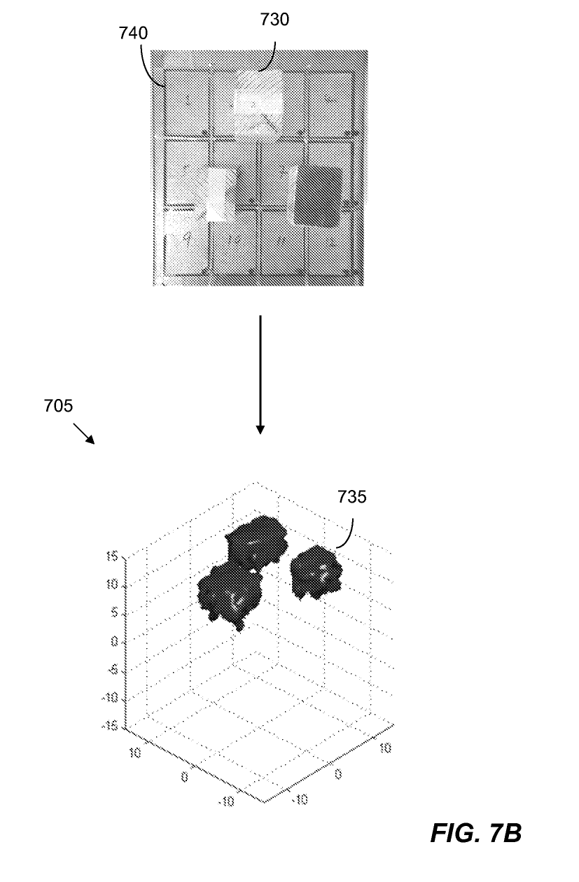

FIG. 7A shows a three-dimensional representation 700 of magnetic induction tomography performed with an IMIECT device. As shown in the upper image of FIG. 7A a region of interest comprises a volume of air or free space with three aluminium samples 720 mounted on wooden blocks. A plurality of first sensor components 710, in this case sixteen coils mounted in a four-by-four planar array, are used to sense the region of interest and provide measurements to generate the three-dimensional representation 700. Within the three dimensional representation 700 the position of the first sensor components are represented as 715. Image portions 725 then represent the three aluminium samples 720. For example, the three dimensional representation may represent electrical conductivity and/or permeability values in the region of interest. In this example, as aluminium is conductive, but the wooden blocks and surrounding air space is not, only elements representing the aluminium samples are shown in the three dimensional representation 700 of, for example, electrical conductivity and/or permeability.

FIG. 7B demonstrates how data from a set of second sensor components may be used to image non-conductive and/or dialectic samples. FIG. 7B shows a three-dimensional representation 705 of electrical capacitive tomography performed with an IMIECT device. This may comprise electrical capacitive tomography that is corrected and/or calibrated based on inductive measurements as described above. As shown in the upper image of FIG. 7B a region of interest comprises a volume of air or free space with three wooden samples 730. A plurality of second sensor components 740, in this case twelve electrodes mounted in a four-by-three planar array, are used to sense the region of interest and provide measurements to generate the three-dimensional representation 705. Image portions 735 then represent the three wooden samples 730. For example, the three dimensional representation may represent permittivity or dialectic characterisation values in the region of interest. If the region of interest in FIG. 7B contained conductive elements and/or objects as well as the wooden samples, it may be difficult to determine the electromagnetic properties of the wooden samples. Certain presently described examples address this problem by calibrating capacitive measurements based on detected conductors in the region of interest.

A number of example methods for measuring one or more electromagnetic properties of a region of interest, and/or objects within said region, will now be described. These example methods may be implemented using any one of the previously described apparatus. Alternatively, the methods may be implemented using other apparatus and/or systems.

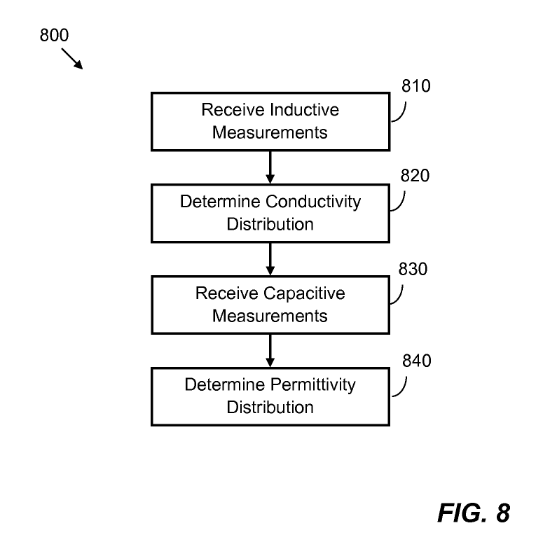

FIG. 8 shows a method 800 of measuring one or more electromagnetic properties of a region of interest. At block 810 one or more inductive measurements are received. These may comprise a plurality of inductive measurements from a set of first sensor components as described previously. At block 820 a conductivity distribution is determined based on the received inductive measurements. At block 830 one or more capacitive measurements are received. These may comprise a plurality of capacitive measurements from a set of second sensor components as described previously. At block 840 a permittivity distribution is determined. This may comprise determining a dielectric characterisation of the region of interest. The permittivity distribution is determined based on the one or more capacitive measurements. In certain cases, the permittivity distribution is determined using the conductivity distribution produced at block 820, for example, a correction and/or calibration may be applied to block 840 based on the presence of one or more regions of conductance in the region of interest.

In one example, each measurement may correspond to a different spatial portion of the region of interest. For example, the measurements may comprise a multi-dimensional array where each element of the array corresponds to a particular area or volume in the region of interest. In one case, a sensor component may be aligned with a spatial portion of the region of interest, e.g. may be arranged so as to have a relative spatial position with respect to said region. The mapping between a measurement from a sensor component and portion of the region of interest may be indirect. When using interleaved arrangements such as those shown in FIGS. 2A and 2D, raw data received from the sensor components may be processed such that it corresponds to a particular portion of the region of interest. For example, data from each set of eight sensor components in FIGS. 2A and 2D may be interpolated to provide a four-by-four array of measurements. In the case of the apparatus 115 in FIGS. 1C and 1D and apparatus 305 in FIGS. 3A to 3C, as well as other planar array arrays, a portion of the region of interest may be measured by a set of sensor components, in some cases a plurality of sensor components that are not being driven by a first or second signal. Raw measurement data may then be correlated to associate a particular measurement with a portion of the region of interest. This correlation may be implicit in the processing performed by one or more of the signal processor 430 and topography processor 610 as described previously. For example, a Jacobian matrix for a set of linear equations may associate a measurement with a particular spatial area or volume of the region of interest.

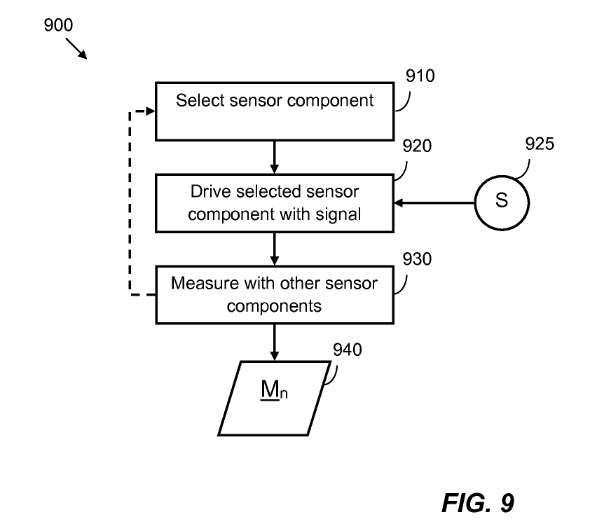

FIG. 9 shows a method of driving one or more sensor components according to an example. This method may complement the blocks of receiving measurements. It may be implemented by one or more of the signal processor 430 and signal controller 450 as shown in FIG. 4C. At block 910 a sensor component is selected. In a case such as that shown in FIGS. 4D and 4E this may involve selecting one or more initial sensor components in a set of sensor components. In a case such as that shown FIG. 4F this may involve selecting a set of transmitter sensor components. Such transmitter sensor components may be fixed (e.g. statically designated) for an implementation and/or dynamically selected as a subset of a plurality of sensor components. At block 920 the one or more selected sensor components are driven with a signal S 925. This may comprise applying a direct current (DC) and/or alternating current (AC) (and/or voltage) to a sensor component. The driving signal S 925 may have a frequency component, e.g. comprise a radio-frequency signal with a particular carrier frequency. At block 930, a measurement is recorded from one or more sensor components. These may comprise a subset of sensor components that do not include the one or more driven sensor components. The subset of sensor components for measurement may be fixed (e.g. statically designated) for an implementation and/or dynamically selected as a subset of a plurality of sensor components. In certain embodiments the subset of sensor components may be driven with a unity current so as to measure perturbations from unity. Measurements recorded at block 930 form part of measurement data Mₙ 940. The method may be repeated as indicated by the dotted arrow in FIG. 9. In a case such as that shown in FIGS. 4D and 4E, at the repetition of block 910 another sensor component in a sequence of sensor components may be selected. In one case the method may be repeated for different frequencies in a frequency range, e.g. signal S 925 may have a different carrier wave frequency for a repetition of the blocks. In one case the method may be repeated for a particular time interval, e.g. every x milliseconds. In theses case the measurement data Mₙ 940 may comprise tuples indexed by one or more of the selected sensor component, driving frequency and time.

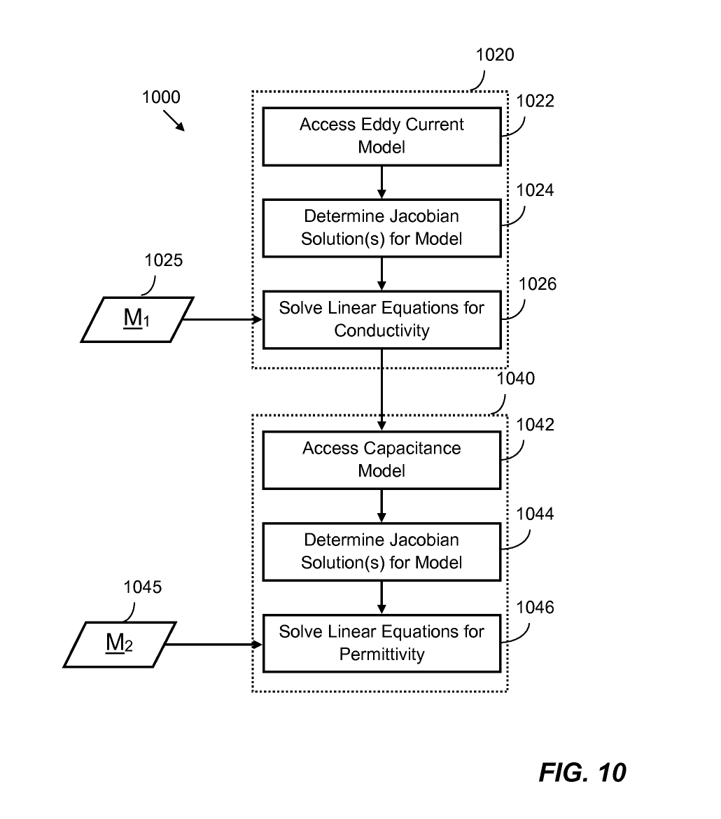

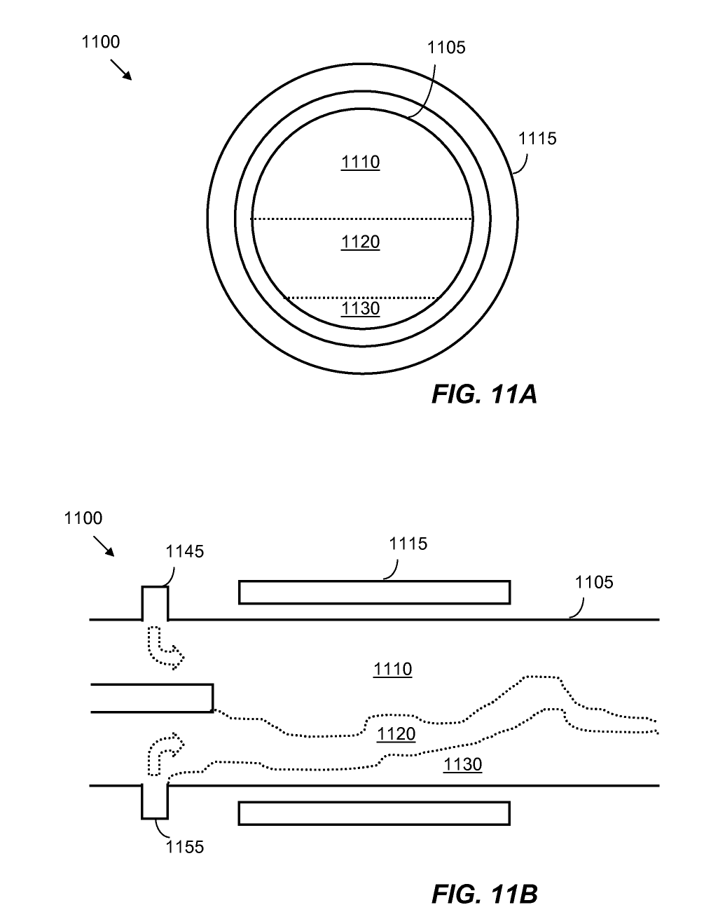

FIG. 10 shows a method 1000 that may be used to implement at least blocks 820 and 840 in FIG. 8. For example, block 1020 may correspond to block 820 in FIG. 8 and block 1040 may correspond to block 840 in FIG. 8. At a first sub-block 1022 of block 1020 an eddy current model is accessed. The model may be based on a forward problem. The model may be based on Maxwell's Equations, for example the differential version of Ampere's circuit law with Maxwell's correction. A model may be formulated in terms of the magnetic vector potential A, where ∇×A=B and B is the magnetic flux density, for the sinusoidal waveform excitation case using complex phasor notation:

$$∇ \times ( \frac{1}{μ} ∇ \times A ) + i ωσ A = J ,$$

where σ is electrical conductivity, μ is magnetic permeability, ω is the angular frequency of a driving signal ∇ is the curl operator and Jₛ is the applied current density in one or more first sensor components, for example an excitation coil in certain examples.

At sub-block 1024 a Jacobian matrix is accessed and/or generated based on the eddy current model. For example, the Jacobian matrix may model a change in induced voltages in one or more first sensor components as a result of a change in electrical conductivity. For example, an element in the Jacobian matrix may be represented as:

$$\frac{\partial {V}_{mn}}{\partial {σ}_{k}} = - {ω}^{2} \frac{Ω {\int }_{Dk} {A}_{m} \cdot {A}_{n} d v}{{I}_{0}}$$

where Vₘₙ is a measured voltage in first sensor component n when excited by driven first sensor component m; σₖ is the conductivity of pixel k, where a pixel represents a particular spatial portion or sub-region of a region of interest; Ω_{Dk} is a volume of a perturbation associated with pixel k, e.g. a volume of a portion of the region of interest; and Aₘ and Aₙ are respectively solutions of a solver for the forward problem when first sensor component m is excited by current I₀ and first sensor component n is excited with unity current. When the forward problem is solved by a solver the elements of the Jacobian matrix are populated. The populated Jacobian matrix may then be used to determine a conductivity distribution. In certain examples, the Jacobian matrix may be at least partially populated (and in certain cases fully populated) before a measurement phase. For example, this may be possible in cases where a standard set of measurement parameters are used. In this case, sub-block 1024 may comprise retrieving populated values for the Jacobian matrix from memory and/or a data storage device.

At sub-block 1026 the populated Jacobian matrix is used to solve one or more linear equations to determine an electrical conductivity distribution. This may represent a solution to an inverse problem associated with the forward (eddy current) problem. For example, a linear response equation may be solved using a least-squares method or the like. In certain cases a Tikhonov regularisation is applied. This may comprise adding a regularisation term to the Jacobian matrix. For example, the following set of linear equations may be solved:

$$[ \begin{matrix}J \\ αI\end{matrix} ] x = [ \begin{matrix}b \\ 0\end{matrix} ]$$

where J is the previously populated Jacobian; I is the identity matrix; α is a regularisation term; b is a set of sensor measurement changes and x is an estimate for the electrical conductivity distribution. In the present sub-block, b may comprise, or be determined based on, (inductive) measurement data M₁ 1025, which may comprise measurement data as described previously with reference to FIGS. 4A to 4C.

The result of block 1020 is an electrical conductivity distribution in one or more dimensions. The sub-blocks described above may be iteratively repeated to determine different dimensional portions of a multi-dimension electrical conductivity distribution. In the present example, the electrical conductivity distribution is used in block 1040.

At a first sub-block 1042 in block 1040 a capacitance model is accessed. This capacitance model may comprise a forward model, for example based on the following equation:

(σ+iω∈₀∈ᵣ)∇φ=0

where φ is the electric potential, ω is the angular frequency of a driving signal, σ is the electrical conductivity distribution received from block 1020, ∈ᵣ is the permittivity of the region of interest, and ∈₀ is the permittivity of a vacuum. In this manner electrical conductivity information is fed into an electrical capacitance forward model. This forward model, for example based on the above equation, may be solved using a finite element method (FEM) resulting in the calculation of a further Jacobian matrix at sub-block 1044. This further Jacobian matrix (J) may represent how measured capacitances change when permittivity changes, e.g. a ∂C=J∂∈. As before, if possible given the implementation, at least a portion of the further Jacobian matrix may be predetermined based on parameters whose values are known a priori. A populated version of the further Jacobian matrix may be used in a set of linear equations that represent a solution of the inverse problem associated with a forward (complex conductivity) problem. At sub-block 1046 these linear equations may be solved to generate an estimate for a permittivity distribution. Again the linear equations may be regularised using a Tikhonov regularisation, such that the linear equations comprise:

$$[ \begin{matrix}J \\ αI\end{matrix} ] x = [ \begin{matrix}b \\ 0\end{matrix} ]$$

where J is the further Jacobian matrix determined using the electrical conductivity distribution, I is the identity matrix; α is a regularisation term; b is a set of sensor measurement changes and x is an estimate for the electrical conductivity distribution. In the present sub-block, b may comprise, or be determined based on, (capacitive) measurement data M₂ 1045, which may comprise measurement data as described previously with reference to FIGS. 4A to 4C.

An output of block 1040 is thus a permittivity image reconstruction that is constructed using conductivity-compensated capacitive imaging data. In total, the output of block 1020 and 1040 may be used to determine a full complex impedance map or image.

In certain examples, the eddy current and complex conductivity models may be tomography models. Where an object or sample being imaged is moving there may be certain degrees of correlation that exist between each consecutive image. In this case, a temporal algorithm may be implemented as part of the inverse problem solver to include the correlation information between the measurement images or frames.

Certain examples described herein provide an apparatus and method, e.g. an instrument and process that may be used for material characterisation of complex, multi-material samples. For example, certain apparatus and methods described herein enable the characterisation of materials in a region of interest comprising a combination of both dielectric and conductor parts. Certain apparatus provide an integrated magnetic induction and electrical capacitance tomography (IMIECT) sensor. This sensor may provide two or three dimensional images representative of one or more electromagnetic properties of an object or material. Certain apparatus are capable of performing measurements on both high-and-low and high conductivity materials.

In certain examples, eddy current methods and processors are used to obtain inductive measurements. These measurements may be used to determine electrical conductivity and/or permeability. Certain methods and processors enable a conductive part of an object or portion of a region of interest to be monitored without substantial effect from dielectric parts. Using these techniques the presence of conductors in a region of interest may be determined. This may then be used to calibrate capacitance measurement to accurately characterise dielectric samples using capacitive methods. For example, certain methods and processors allow characterisation of materials with dielectric contrasts in the presence of conductors. This enables, for example, characterisation of dielectric materials in the presence of saline water or metals. In this manner characterisation may be performed for a metal conduit coated with a polymer sheath carrying a two-phase flow of salt water and petroleum.

Certain examples enable the mapping of complex conductivity by combining capacitive and eddy-current (e.g. inductive) sensors. Tomographic data fusion may then be performed using the measured output of the integrated device. Within this system the eddy-current technique is relatively insensitive to dielectric variations and the capacitive system maps dielectric materials if conductors are identified by the eddy-current technique. This then increases the reliability of capacitance imaging, and thus dielectric characterisation, in the presence of conductors, e.g. ranging from saline solutions to metals. If the presence of the conductors is known, then the capacitance measurements can be calibrated to accurately characterise the dielectric samples.

As set out above, certain examples herein integrate Magnetic Induction Tomography (MIT) and Electrical Capacitive Tomography (ECT) in a single device. MIT is also sometimes referred to as electromagnetic induction tomography, electromagnetic tomography (EMT) or eddy current tomography. By measuring magnetic induction, contactless and non-invasive imaging of the conductivity and permeability of materials contained within a sensor framework may be performed using an eddy current method. This imaging is readily applicable to highly-conductive materials. By increasing an excitation frequency, it also possible to measure low-conductivity samples. This imaging is complemented by performing capacitive imaging based on capacitive measurements. For example, capacitive imaging is sensitive to variations in the dielectric permittivity at frequencies below 20 MHz; these are case where the quasi-static magnetic field may dominate and thus reduce the accuracy of inductive measurements in relation to dielectric permittivity. An integrated instrument, whether than be a signal processor or signal processor and sensor set, is thus capable of measuring across an entire range of electric properties. It, for example, enables an MIT device to be adapted to allow sensitivity to permittivity.

Certain examples described herein use data fusion and multi-modality imaging approaches. For example, the signal processor 430 of FIGS. 4A to 4C and FIGS. 5 and 6 may receive measurements based on both magnetic induction and electrical capacitance and the effect of changes in permittivity and/or conductivity on each measurement may be considered.

Certain examples described herein make use of a Jacobian matrix, wherein elements of a Jacobian matrix may represent the derivative of a measured capacitance, or inductance, with respect to a change in permittivity, or conductivity and permeability, of pixels or voxels.

Certain examples described herein have a wide range of industrial applications. Apparatus may be contactless and non-invasive. This enables non-destructive evaluation. This has advantages for industrial process monitoring and material characterisation, in particular where there is a mixture of conductive and dielectric materials. Certain examples and methods described herein may also be used for multiphase flows. An example of the latter is described below with reference to FIGS. 10A and 10B.

FIG. 10A shows an example application 1000 of an apparatus described in certain examples herein. A conduit 1005 carries a multiphase flow. The multiphase flow of FIG. 10A has three phases: a first phase 1010, a second phase 1020 and a third phase 1030. An apparatus 1015, which may comprise one of the previously described apparatus, is mounted in relation to the conduit 1005. The apparatus 1015 is shown as a solid body in FIG. 10A for ease of example; in an implementation it may comprise a plurality of individual sensor mountings such as is shown in FIGS. 3A to 3C. FIG. 10B shows a side view of the same application. In this case the first phase 1010 is received through inlet 1045 and the second and third phases 1020, 1030 are received via inlet 1055. In the conduit the phases mix as shown in FIG. 10B. The apparatus 1005 is then able to image this mixing using the techniques described in the examples. For example, a three-phase flow may comprise gas as the first phase 1010, a saline solution such as sea water as the second phase 1020 and a solid such as sand as the third phase 1030. Alternatively, a three-phase flow may comprise gas as the first phase 1010, oil as the second phase 1020 and a saline solution such as sea water as the third phase 1020. As a saline solution is conductive and the other phases are dielectric this would traditionally be difficult to image using electrical capacitance tomography or magnetic induction tomography; however, the integrated approach described in examples herein allow imaging of both conductive and dielectric aspects. For example they enable measurement of the concentration of one fluid in another, or the distribution of a solid in a fluid. They furthermore allow this in a non-invasive manner in situations where the conduit comprises a combination of conductive and non-conductive materials. In a similar manner, the techniques described herein may also be applied to monitor cables such as undersea cables. In these situations there may be a conductive element (e.g. a copper core) surrounded by one or more insulating elements (e.g. a polymer sheath) in a conductive environment (e.g. sand and/or sea water). The differing electromagnetic properties of these elements may be successfully imaged using the examples described herein.

In another example application a region of interest may comprise a structure comprising a mixture of materials with different electromagnetic properties. For example, the apparatus 110 shown in FIGS. 1A and 1B may be used to image concrete structures with reinforced steel bars. In this case the techniques described herein may be used to monitor corrosion of steel elements as well as monitor the integrity of the concrete structure. Similarly the techniques may also be applied to composite structures such as aircraft or wind turbine components. For example, they may be used to survey large area impact damage in composite carbon fibre and/or glass fibre structures. They may also be applied safely in the nuclear industry. As a further example, the techniques may be used to image conductive and dielectric elements in geophysical surveys. The techniques operate successfully even with moist soil (which is more conductive than dry soil) and are able to detect buried ceramic objects and, in general, materials with a combination of metallic and dielectric contrast.

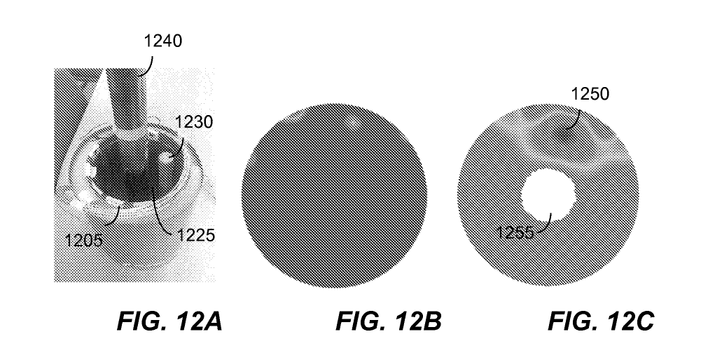

A test case will now be described with reference to FIGS. 12A, 12B and 12C. This test case demonstrates how, using certain examples described herein, tomographic imaging may be improved over a comparative ECT imaging case.

FIG. 12A shows a photo of a test arrangement. The test arrangement comprises a sensor arrangement 1210. The sensor arrangement 1210 has a region of interest 1225. This sensor arrangement 1210 may be constructed as described with reference to any one of FIGS. 2A to 2E or 3A to 3C. For example, in the case that sensor arrangement 1210 comprises sensor arrangement 305, region of interest 325 may be an interior of the sensor arrangement 1210, i.e. region of interest 1225. In this test case there are two test samples within the region of interest: an insulating wooden block 1230 and a conducting metal rod 1240.

FIG. 12B shows an example output for the test case from a comparative ECT processor. For example, in this comparative case, an ECT tomographic apparatus may comprise 12 electrodes with a radial screen between the electrodes and external shielding. In this ECT tomographic apparatus, the size of each electrode may be 217×32 mm² and the screens between the electrodes may be 3 mm wide. A Process Tomography Limited (PLT) 300E ECT capacitance measurement unit may be used with an excitation frequency fixed at 1.25 MHz. Twelve channels may be connected to the electrodes to measure the inter-capacitance. FIG. 12B shows a comparative output from such an apparatus. It shows a tomographic image where ECT processing is performed with a reference measurement of air. As can be seen, imaging the mixture of conductive and insulating materials is not possible: the comparative output image is mostly blank with a few areas of noise.

FIG. 12C shows an example output for the test case when using an example tomography processor as described herein, e.g. this may be an output of example 600 such as tomogram 620. In this case, the presence and location of the conductive material, i.e. the conducting metal rod 1240, is accommodated by way of an estimate of electrical conductivity and the example output is generated using this estimate of electrical conductivity, together with one or more capacitive measurements. For example, a tomogram may be generated based on an estimated permittivity measurement as described herein. Comparing the output shown in FIG. 12C with the output shown in FIG. 12B, the presence and location of the insulating wooden block 1230 is clearly shown in area 1250 of FIG. 12C and the presence and location of the conducting metal rod 1240 is resolved from the conductivity estimate, as shown by area 1255. In other words, the updated background data and forward model, e.g. updated to include the conductivity estimate, provides a clear distribution of dielectric as shown in FIG. 12C.

Certain techniques described herein may be used to measure electromagnetic properties. These may be passive electromagnetic properties including one or more of electrical conductivity, permeability, permittivity and complex impedance. For example, an apparatus and/or signal processor described herein may be capable of mapping electrical impedance including permittivity and electrical conductivity. In certain examples described herein, measurements are performed at a plurality of frequencies; this further spectroscopic analysis of the afore-mentioned passive electromagnetic properties. In certain cases the measurements described herein may be differential, e.g. they may represent changes between success measurements or deviations from a known set of values.

According to one example described herein, there is provided apparatus for determining one or more electromagnetic properties of a region of interest comprising at least one measurement interface for receiving one or more inductive measurements corresponding to the region of interest and one or more capacitive measurements corresponding to the region of interest and a signal processor communicatively coupled to the at least one measurement interface and arranged to obtain an estimate of electrical conductivity based on at least the received one or more inductive measurements and to determine a permittivity measurement using at least the estimate of electrical conductivity and the received one or more capacitive measurements.

In certain examples, the signal processor is arranged to use said one or more inductive measurements to calibrate said one or more capacitive measurements. The signal processor may be arranged to determine an estimate of electrical conductivity for a plurality of sub-regions of the region of interest and to determine a Jacobian matrix associated with the capacitive measurements, the Jacobian matrix being compensated based on the estimate of electrical conductivity. The signal processor may also be arranged to output measurements for one or more of electrical conductivity, permeability, permittivity and complex impedance.

In certain examples, the apparatus comprises a topology processor communicatively coupled to the signal processor and arranged to map the spatial distribution of one or more electromagnetic properties in the region of interest.

In one case the apparatus comprises one or more first sensor components electrically coupled to the at least one measurement interface, at least one first sensor component being arranged to provide an inductive measurement corresponding to a region of interest proximate to the apparatus on application of a first signal and one or more second sensor components electrically coupled to the at least one measurement interface, at least one second sensor component being arranged to provide a capacitive measurement corresponding to said region of interest proximate to the apparatus on application of a second signal. One or more of the first and second signals may comprise at least one frequency component. In this case, a signal controller may be arranged to supply one or more of the first signal to one or more of the first sensor components, wherein during a measurement phase at least one of the first sensor components transmits said first signal and one or more inductive measurements are recorded from at least one other first sensor component and the second signal to one or more of the second sensor components, wherein during a measurement phase at least one of the second sensor components transmits said second signal and one or more capacitive measurements are recorded from at least one other second sensor component. The signal controller may also be arranged to supply one or more of the first signal to each of the first sensor components in turn, the set of other first sensor components in the plurality of first sensor components being used to provide a plurality of inductive measurements and the second signal to each of the second sensor components in turn, the set of other second sensor components in the plurality of second sensor components being used to provide a plurality of capacitive measurements. In some implementations, the signal controller is arranged to communicate the first and second signals to the signal processor and the signal processor is arranged to use said signals when determining one or more electromagnetic properties of the region of interest.

In the above cases, one or more of the plurality of first sensor components and the plurality of second sensor components may be arranged to provide a plurality of voltage measurements. In some implementations, the first sensor components are interleaved with the second sensor components. A first sensor component and a second sensor component may be combined in a common electrode arrangement. They may be arranged in one or more corresponding planar arrays and/or may be electrically separated or isolated from the region of interest by an insulator (e.g. non-contact).

In certain cases, the signal processor is arranged to use the permittivity measurement obtain a subsequent estimate of electrical conductivity.

According to one example described herein, there is provided a method of measuring one or more electromagnetic properties of a region of interest comprising receiving one or more inductive measurements corresponding to the region of interest, determining a distribution for electrical conductivity in the region of interest based on at least the received inductive measurements, receiving one or more capacitive measurements corresponding to the region of interest and using at least the distribution for electrical conductivity and the one or more capacitive measurements to determine a distribution for permittivity in the region of interest. Determining a distribution for electrical conductivity may comprise determining a distribution for permeability in the region of interest based on the received inductive measurements. The output of the method may be a complex impedance map of the region of interest based on the determined distributions. The method may be provided as a computer program.

In one case, sensor components are aligned with the region of interest and one or more of receiving one or more inductive measurements and receiving one or more capacitive measurements comprises driving one or more sensor components in the plurality of sensor components with a signal and measuring a response in one or more other sensor components in the plurality of sensor components. The signal may have at least one frequency component. In this case, driving one or more sensor components may comprise driving one or more sensor components with a plurality of signals, each signal having a different frequency component, and wherein said distributions are determined for a frequency domain.

In an example, determining a distribution comprises determining an image representing a spatial distribution of an electromagnetic property in the region of interest and/or determining a three-dimensional image representing a volumetric distribution of an electromagnetic property in the region of interest.

In certain cases, the method is repeated, wherein determining a distribution for electrical conductivity in the region of interest comprises using a previously determined distribution for permittivity.

According to one example described herein, there is provided apparatus for measuring one or more electromagnetic properties of a region of interest, comprising a plurality of first sensor components arranged in a planar array, the first sensor components being arranged to provide inductive measurements corresponding to a region of interest proximate to the apparatus on application of a first signal, the inductive measurements being used to perform magnetic induction tomography on the region of interest and a plurality of second sensor components integrated with the one or more first sensor components in the planar array, the second sensor components being arranged to provide capacitive measurements corresponding to said region of interest proximate to the apparatus on application of a second signal, the capacitive measurements being used to perform electrical capacitance tomography on the region of interest. The plurality of first sensor components may be interleaved with the plurality of second sensor components and/or a first sensor component and a second sensor component are combined in a common electrode arrangement. The plurality of first sensor components and the plurality of second sensor components may be electrically separated from the region of interest by an insulator.

According to one described example, there is provided apparatus for measuring one or more electromagnetic properties of a region of interest, comprising a plurality of first sensor components arranged in a planar array, the first sensor components being arranged to provide inductive measurements corresponding to a region of interest proximate to the apparatus on application of a first signal, the inductive measurements being used to perform magnetic induction tomography on the region of interest, and a plurality of second sensor components integrated with the one or more first sensor components in the planar array, the second sensor components being arranged to provide capacitive measurements corresponding to said region of interest proximate to the apparatus on application of a second signal, the capacitive measurements being used to perform electrical capacitance tomography on the region of interest.

In certain cases, wherein the plurality of first sensor components are interleaved with the plurality of second sensor components. In certain cases, a first sensor component and a second sensor component are combined in a common electrode arrangement. The plurality of first sensor components and the plurality of second sensor components may be electrically separated from the region of interest by an insulator.

At least some aspects of the examples described herein with reference to the drawings may be implemented using computer processes operating in one or more processing systems or one or more processors. For example, these processing systems or processors may implement the signal processor 430, signal controller 450 and/or other described components. These aspects may also be extended to computer programs, particularly computer programs on or in a carrier, adapted for putting the aspects into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

Similarly, it will be understood that any apparatus referred to herein may in practice be provided by a single chip or integrated circuit or plural chips or integrated circuits, optionally provided as a chipset, an application-specific integrated circuit (ASIC), field-programmable gate array (FPGA), etc. The chip or chips may comprise circuitry (as well as possibly firmware) for embodying at least a data processor or processors as described above, which are configurable so as to operate in accordance with the described examples. In this regard, the described examples may be implemented at least in part by computer software stored in (non-transitory) memory and executable by the processor, or by hardware, or by a combination of tangibly stored software and hardware (and tangibly stored firmware).

The above examples are to be understood as illustrative. Further examples are envisaged. Any values or numerical quantities presented in the examples are for ease of explanation and may represent a simplification of one implementation out of a number of possible implementations. Any described features of any of the examples, whether method or apparatus, may apply to any other example, whether method or apparatus. For example, it is to be understood that any feature described in relation to any one example may be used alone, or in combination with other features described, and may also be used in combination with one or more features of any other of the examples, or any combination of any other of the examples. Furthermore, equivalents and modifications not described above may also be employed without departing from the scope of the invention, which is defined in the accompanying claims.

What is claimed is:

1. A system for use in determining electromagnetic properties of a region of interest, the system comprising:
at least one memory including computer program code;
at least one measurement interface for receiving one or more inductive measurements corresponding to the region of interest and one or more capacitive measurements corresponding to the region of interest; and
at least one processor in data communication with the at least one memory and the at least one measurement interface, wherein the at least one processor is configured to obtain an estimate of electrical conductivity based on at least the received one or more inductive measurements and to determine a permittivity measurement using at least the estimate of electrical conductivity and the received one or more capacitive measurements.

2. The system of claim 1, wherein the at least one processor is configured to use the one or more inductive measurements to calibrate the one or more capacitive measurements.

3. The system of claim 1, wherein the at least one processor is configured to determine an estimate of electrical conductivity for a plurality of sub-regions of the region of interest and to determine a Jacobian matrix associated with the capacitive measurements, the Jacobian matrix being compensated based on the estimate of electrical conductivity.

4. The system of claim 1, wherein the at least one processor is configured to map the spatial distribution of one or more electromagnetic properties in the region of interest.

5. The system of claim 1, wherein the at least one processor is configured to output measurements for one or more of electrical conductivity, permeability, permittivity and complex impedance based on at least one of: the one or more inductive measurements corresponding to the region of interest and the one or more capacitive measurements corresponding to the region of interest.

6. The system of claim 1, comprising:
one or more first sensor components electrically coupled to the at least one measurement interface, at least one first sensor component being arranged to provide an inductive measurement corresponding to a region of interest proximate to the system on application of a first signal; and
one or more second sensor components electrically coupled to the at least one measurement interface, at least one second sensor component being arranged to provide a capacitive measurement corresponding to the region of interest proximate to the system on application of a second signal.

7. The system of claim 6, comprising:
a signal controller arranged to supply one or more of:
the first signal to one or more of the first sensor components, wherein during a measurement phase at least one of the first sensor components transmits the first signal and one or more inductive measurements are recorded from at least one other first sensor component; and
the second signal to one or more of the second sensor components, wherein during a measurement phase at least one of the second sensor components transmits the second signal and one or more capacitive measurements are recorded from at least one other second sensor component.

8. The system of claim 7, wherein the signal controller is arranged to supply one or more of:
the first signal to each of the first sensor components in turn, the set of other first sensor components in the plurality of first sensor components being used to provide a plurality of inductive measurements; and
the second signal to each of the second sensor components in turn, the set of other second sensor components in the plurality of second sensor components being used to provide a plurality of capacitive measurements.

9. The system of claim 7, wherein the signal controller is arranged to communicate the first and second signals to the at least one processor, and wherein the at least one processor is configured to use the first and second signals when determining one or more electromagnetic properties of the region of interest.

10. The system of claim 6, wherein one or more of the first and second signals comprise at least one frequency component.

11. The system of claim 6, wherein one or more of the plurality of first sensor components and the plurality of second sensor components are arranged to provide a plurality of voltage measurements.

12. The system of claim 6, wherein the first sensor components are interleaved with the second sensor components.

13. The system of claim 6, wherein a first sensor component and a second sensor component are combined in a common electrode arrangement.

14. The system of claim 6, wherein one or more of the plurality of first sensor components and the plurality of second sensor components are arranged in one or more corresponding planar arrays.

15. The system of claim 6, wherein the plurality of first sensor components and the plurality of second sensor components are electrically separated from the region of interest by an insulator.

16. The system of claim 1, wherein the at least one processor is configured to use the permittivity measurement to obtain a subsequent estimate of electrical conductivity.

17. A method of measuring electromagnetic properties of a region of interest comprising:
receiving one or more inductive measurements corresponding to the region of interest;
determining a distribution for electrical conductivity in the region of interest based on at least the received inductive measurements;
receiving one or more capacitive measurements corresponding to the region of interest; and
using at least the distribution for electrical conductivity and the one or more capacitive measurements to determine a distribution for permittivity in the region of interest.

18. The method of claim 17, wherein determining a distribution for electrical conductivity comprises determining a distribution for permeability in the region of interest based on the received inductive measurements.

19. The method of claim 17, comprising:
determining a complex impedance map of the region of interest based on the determined distributions.

20. The method of claim 17, wherein sensor components are aligned with the region of interest and one or more of receiving one or more inductive measurements and receiving one or more capacitive measurements comprises:
driving one or more sensor components in the plurality of sensor components with a signal and measuring a response in one or more other sensor components in the plurality of sensor components.

21. The method of claim 20, wherein the signal has at least one frequency component.

22. The method of claim 21, wherein driving one or more sensor components comprises driving one or more sensor components with a plurality of signals, each signal having a different frequency component, and wherein the distributions are determined for a frequency domain.

23. The method of claim 17, wherein determining a distribution comprises determining an image representing a spatial distribution of an electromagnetic property in the region of interest.

24. The method of claim 17, wherein determining a distribution comprises determining a three-dimensional image representing a volumetric distribution of an electromagnetic property in the region of interest.

25. The method of claim 17, comprising:
repeating the steps of the method, wherein determining a distribution for electrical conductivity in the region of interest comprises using a previously determined distribution for permittivity.
